(19) United States
(12) Patent Application Publication
(10) Pub. No.: US 2016/0364795 A1
(43) Pub. Date: Dec. 15, 2016

(54) SYSTEMS AND METHODS FOR EXTENDING CREDIT TO SMALL/MEDIUM-SIZED ENTERPRISES

(71) Applicant: MasterCard International Incorporated, Purchase, NY (US)

(72) Inventors: Deepankar Bhagat, Chesterfield, MO (US); Michael Denis McCarthy, New York, NY (US); Erik Lukas Ekselius, Overijse (BE); Mark N. Savoye, Hartsdale, NY (US)

(21) Appl. No.: 14/735,763

(22) Filed: Jun. 10, 2015

(51) Int. Cl. G06Q 40/02; G06Q 20/20; G06Q 20/40

(52) U.S. Cl. CPC G06Q 40/025; G06Q 20/405; G06Q 20/202

(57) ABSTRACT

A credit account is established for a merchant. A variable credit limit is set for the credit account. An indication is received that the merchant has accepted a payment account transaction to be charged to a customer's payment account. A transaction amount may be associated with the payment account transaction. The indication may also indicate that the payment account transaction has been authorized by an issuer of the customer's payment account. There may be a response in real time to the indication by instantaneously increasing the variable credit limit for the merchant's credit account by an amount that corresponds to the transaction amount.

### BACKGROUND

Access to credit may be a significant issue for many small- and medium-sized enterprises (SMEs), both in developed countries and in developing countries. Moreover, while modern payment systems, based on credit and debit card accounts and the like, have done much to facilitate commerce, for many merchants that accept payment account transactions there may be a time-lag of a number of days before the proceeds of such transactions become available to the merchants.

The present inventors has now recognized an opportunity for a system that supports extension of credit to SMEs, while also facilitating their participation in a payment account system, and providing a suite of business service resources that may improve their insight into their enterprises and aid in business decision-making.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system in accordance with aspects of the present disclosure.

FIG. 3 is a diagram that illustrates aspects of the system of FIG. 2 in relation to enrollment of payment facilitators.

FIG. 4 is a diagram that illustrates aspects of the system of FIG. 2 in relation to enrollment of SMEs/merchants.

FIG. 5 is a diagram that illustrates aspects of the system of FIG. 2 in relation to payment account transaction acceptance by a typical merchant.

FIG. 6 is a diagram that illustrates aspects of the system of FIG. 2 in relation to a payment account purchase transaction made by a typical merchant.

FIG. 7 is a block diagram representation of a typical computer that may provide at least part of the functionality of the system of FIG. 2.

FIG. 8 is a high-level flow chart that illustrates a process that may be performed in the system of FIG. 2.

### DETAILED DESCRIPTION

In general, and to introduce concepts of embodiments of this disclosure, a payment system feature that allows payment account holders to apply controls to use of their accounts may be adapted to support issuance of credit card accounts to SMEs. The credit card accounts, in some embodiments, may be issued to the SMEs by payment facilitators or similar entities that in turn have been issued credit accounts by a payment account issuer such as a financial institution (FI). The credit card accounts issued to the SMEs may be identified by VCNs (virtual card numbers) that route transactions to an account control facility.

The SMEs may be set up to accept payment account transactions that settle through the above-mentioned FI. As transactions accepted by the SMEs are approved, the respective credit lines for their credit card accounts may be instantaneously increased to reflect the collateral value of the accepted transactions. As the SMEs use their credit card accounts to engage in purchases, the available credit relative to the accounts may be reduced. Both the increases in credit lines and reductions in available credit may be implemented through the control capabilities of the account control facility.

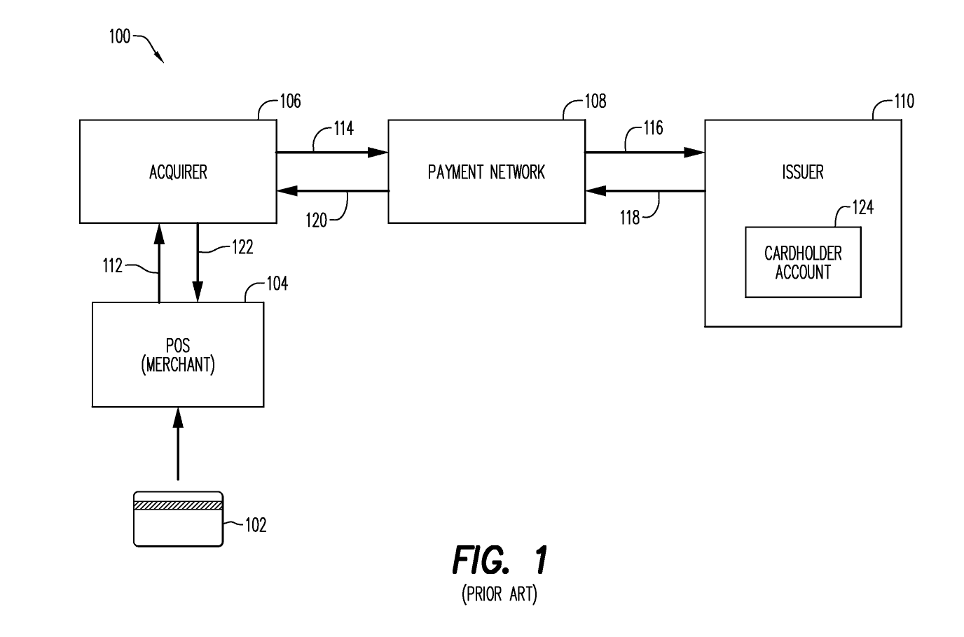

FIG. 1 is a block diagram that illustrates a conventional payment system 100. More specifically, FIG. 1 illustrates actions that occur in connection with a typical purchase transaction performed in the payment system 100. To initiate the transaction, a customer (not shown) visits a retail store (not shown) operated by a merchant, selects goods (not shown) that he/she wishes to purchase, carries the goods to the merchant's point of sale (POS) terminal 104, and presents his/her payment card 102 to the POS terminal 104. The POS terminal 104 reads the customer's payment card account number from the payment card 102, and then sends a transaction authorization request to an acquirer financial institution (FI) 106 with which the merchant has a relationship. The authorization request includes the payment card account number and the amount of the transaction, among other information. The authorization request is routed via a payment network 108 (which may be, for example, the well-known Banknet system operated by MasterCard International Incorporated, the assignee hereof) to the issuer financial institution 110 that issued the customer's payment card 102. Arrows 112, 114 and 116 trace the path of the authorization request from the POS terminal 104 to the issuer 110.

Assuming that all is in order, the issuer financial institution (FI) 110 transmits a favorable transaction authorization response to the POS terminal 104 through the payment card system 108 and via the acquirer FI 106. (The path of the authorization response from the issuer FI 110 to the POS terminal 104 is traced by arrows 118, 120, 122.) The transaction at the POS terminal 104 is then completed and the customer leaves the store with the goods. A subsequent clearing transaction initiated by the merchant results in a transfer of the transaction amount from the customer's payment card account 124 to an account that belongs to the merchant. The customer's payment card account 124 may be, for example, either a debit card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of the typical transaction may be considered to be somewhat simplified in some respects. For example, a so-called merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service may operate to handle payment card transactions on behalf of the acquirer and on behalf of a large number of other like financial institutions.

Moreover, the system components shown in FIG. 1 are only those required for a single transaction. In practice the payment system 100 handles numerous transactions simultaneously and has many issuers, acquirers, merchants and cardholders as participants in the system.

According to some proposals, the credentials embodied in the payment card 102 in the above example may alternatively be digitized into a mobile device such as a smartphone (not shown), which may communicate by short-range radio signaling (e.g., via NFC—“Near Field Communication”) with a suitably equipped POS device.

As is well-known, the payment card 102 may incorporate one or more mechanisms for communicating the customer's payment account number to the merchant 104. These mechanisms may include a magnetic stripe and/or an integrated circuit (not shown) that can exchange data via direct contact or by contactless (short range radio communications) with the reader component (not separately shown) of the POS device 104.

As is familiar to those who are skilled in the art, the role played by the POS terminal in the scenario illustrated in FIG. 1 may alternatively be played by other types of devices. Such devices may include, for example, unattended gasoline pumps that read payment cards; unattended, card-reading vending devices (e.g., transit card dispensing/refilling kiosks); or—in the case of an online e-commerce transaction—a merchant's e-commerce server computer.

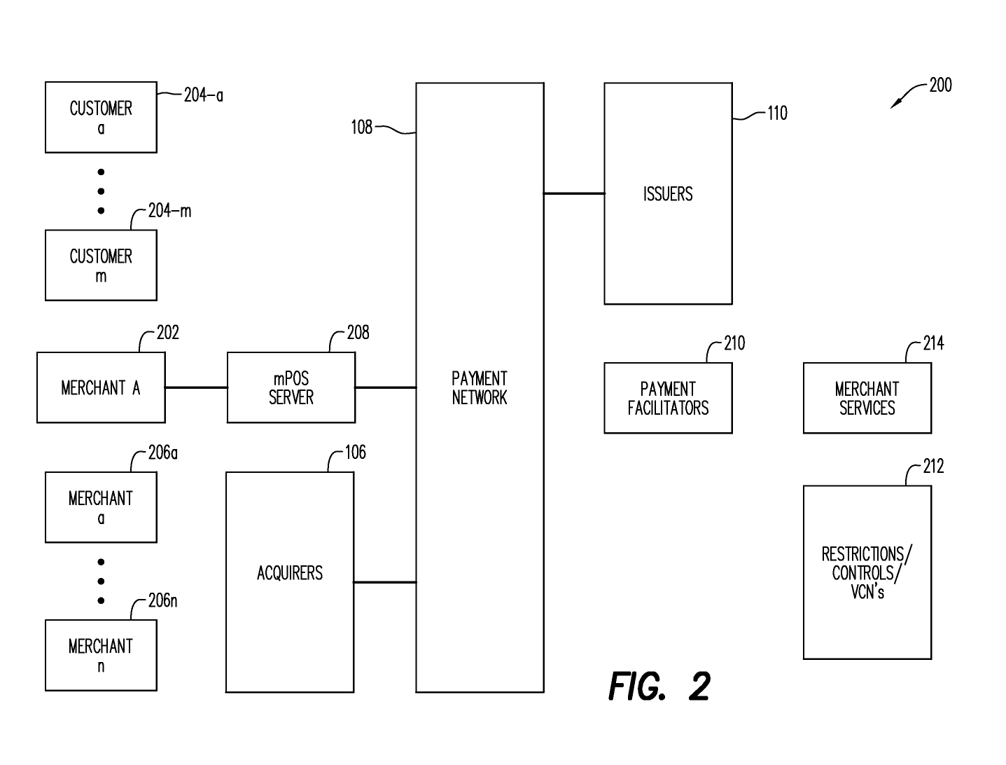

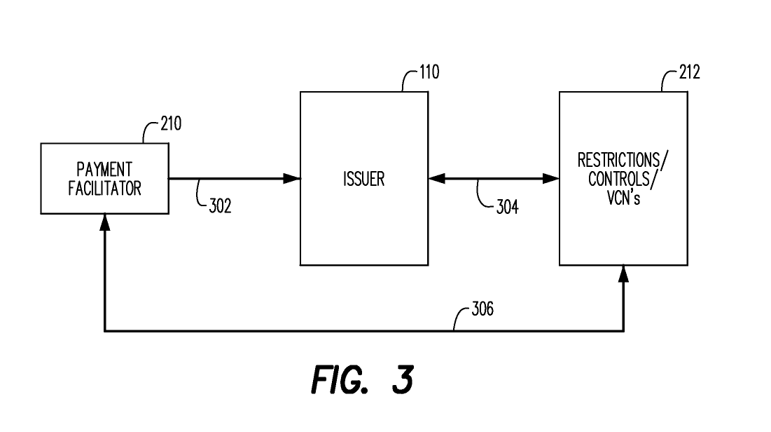

FIG. 2 is a block diagram that illustrates a payment system 200 in accordance with aspects of the present disclosure. Each block in FIG. 2 represents a party that is a participant or potential participant in the payment system 200; each block may also be considered, in at least some cases, to represent a computing device or other device owned or operated by—or operated on behalf of—the respective party represented by the block in question. To simplify the drawing, many communication channels among the various blocks are omitted. Some of such communication channels are explicitly indicated in subsequent drawings (i.e., FIGS. 3-6), and in any case, where interactions between two blocks/parties are referred to in the ensuing description, it is to be understood that such interactions are carried out over suitable communication channels, even if not explicitly shown in FIG. 2 or any other drawing.

Block 108 in FIG. 2 represents the type of payment network that was discussed above and is similarly identified in FIG. 1. By the same token, block 110 in FIG. 2 represents a considerable number of account issuers/FIs, such as the account issuer 110 shown in FIG. 1 and discussed above. Still further, block 106 in FIG. 2 represents a considerable number of acquirers, such as the acquirer 106 shown in FIG. 1 and discussed above.

Continuing to refer to FIG. 2, block 202 represents an SME/merchant that is a principal beneficiary of the advantageous features of the payment system 200 as described herein. Further details concerning the merchant 202, and how it participates in and benefits from the payment system 200, will be described below.

Blocks 204-a through 204-m represent customers or potential customers of the merchant 202. It will be assumed that the customers 204 have payment cards or other devices with which the customers 204 may seek to engage in payment account purchase transactions to be accepted by the merchant 202. It is further assumed that the payment accounts that can be accessed by the payment cards/devices have been issued by respective ones of the account issuers 110. For at least some types of merchant 202, there may theoretically be a large number of potential customers 204.

Blocks 206-a through 206-n represent merchants with which the merchant 202 may interact in the role of a customer. That is, the merchant 202 may use a payment card issued to the merchant 202 to engage in a payment account purchase transaction with one or more of the merchants 206. There will be further discussion below of the manner of issuance of the payment card to the merchant 202, as well as features—provided in accordance with aspects of this disclosure—of the credit card account that corresponds to the payment card issued to the merchant 202.

It is to be understood that each of the merchants 206 has a relationship with at least one of the acquirers 106.

Block 208 in FIG. 2 represents a “mobile POS server” (mPOS server), of a type that has been previously proposed to receive payment account transaction authorization request messages from a mobile device that has been equipped and programmed to accept payment account transactions on behalf of a merchant (in this illustration, merchant 202) that owns or operates the mobile device. In accordance with aspects of the present disclosure, the mPOS server 208 may be modified so as to perform at least some functions according to aspects of the present disclosure in addition to previously proposed functionality for mPOS servers.

Block 210 in FIG. 2 represents a group of entities known as “payment facilitators.” The term “payment facilitator” (PF) is commonly used in the payments industry, and generally refers to an entity that provides an aggregated merchant account and underwrites merchants within the PF's account. For the purposes of the present disclosure and appended claims, the term “payment facilitator” should be understood to include all entities that fall within the usual understanding of the term, as well as any entity that brings about the issuance of the type of merchant credit card account that is described below as being issued to the merchant 202.

Block 212 in FIG. 2 represents a facility that allows payment account holders to exercise one or more options relating to control or operation of their payment accounts. One such facility is operated and made available by MasterCard International Incorporated (the assignee hereof) under the brand name “In Control.” As is understood by those who are skilled in the art, the “In Control” facility allows account holders to define spending limits, restrictions and/or controls, and to set-up conditions under which alerts will be provided to the account holders, and allows creation of VCNs for use as alternative identifiers for their payment accounts. In various contexts herein, the facility 212 will be referred to as an “account control facility,” and/or a “restrictions arbitration computer.” As described in further detail below, the account control facility 212 may, in accordance with aspects of the present disclosure, be operated so as to implement a variable credit limit for the credit card account issued to the merchant 202, in such a way that the credit limit for the account is increased each time there is an approval of a payment account transaction accepted by the merchant 202, and the available credit for the account is reduced each time the merchant 202 uses the account to engage in a purchase from one of the merchants 206 (which may be any and all merchants that accept the brand of credit card account issued to the merchant 202).

As will be understood from the discussion up to this point regarding FIG. 2, the operation of the payment system 200 may be such that the merchant 202 is enrolled both as an acceptor of payment account transactions and as holder of a payment card account (i.e., a credit card account) to which the merchant 202 may charge purchases from other merchants 206. In addition, a payment facilitator 210 that enrolls the merchant 202 for these purposes, and or a cooperating FI/issuer/acquirer and/or the payment network 108 may make a suite of business services/resources (block 214) available to the merchant 202. Examples of such services/resources are described in commonly assigned U.S. patent application Ser. No. 14/183,829, filed Feb. 19, 2014 and published as U.S. Patent Publication No. 2015/______ (Atty docket no. M01.253), which prior application is incorporated herein by reference. In addition to hardware, software and/or services to facilitate the merchant's role as a transaction acceptor, the merchant services 214 may include, in the context of a developed country, resources such as an inventory management system, a purchasing application for SMEs and access to data and/or data analysis tools that may aid the merchant 202 in making business decisions. In the context of a developing country, the merchant services 214 may include a bill payment application, an air-time top-up application and/or an agent cash-in/cash-out application.

FIG. 3 is a diagram that illustrates aspects of the payment system 200 in relation to enrollment of payment facilitators.

As indicated at 302 in FIG. 3, a payment facilitator 210 enrolls with an account issuer 110 and is issued a credit account. In some contexts, this may be a relatively large credit facility, so that the payment facilitator 210 will be able, in turn, to extend credit to a considerable number of merchants like merchant 202 (FIG. 2, not shown in FIG. 3). The resulting account issued to the payment facilitator 210 may be identified by a PAN (primary account number). In enrolling as a credit account holder with the issuer 110, the payment facilitator 210 may also be enrolled with the account control facility 212 to enable to the payment facilitator 210 to cause VCNs to be generated in connection with the credit account issued to the payment facilitator 210. The enrollment of the payment facilitator 210 with the account control facility 212 may be via the issuer 110, as indicated at 304. The payment facilitator 210 may also have the capability for establishing limits, controls, restrictions and/or rules with respect to the VCNs (i.e., with respect to transactions based on the VCNs) generated in the account control facility 212. The communications between the payment facilitator 210 and the account control facility 212 for the purpose of generating and controlling use of VCNs is indicated at 306, and may occur once the payment facilitator 210 is enrolled with the account control facility 212. As will be seen, the VCNs generated by or on behalf of the payment facilitator 210 may be used to identify what will effectively be secured credit card accounts for merchants like the above-mentioned merchant 202. These merchants may be recruited by the payment facilitator 210 to become participants in the payment system 200 and recipients of credit lines and other services provided by the payment facilitator 210.

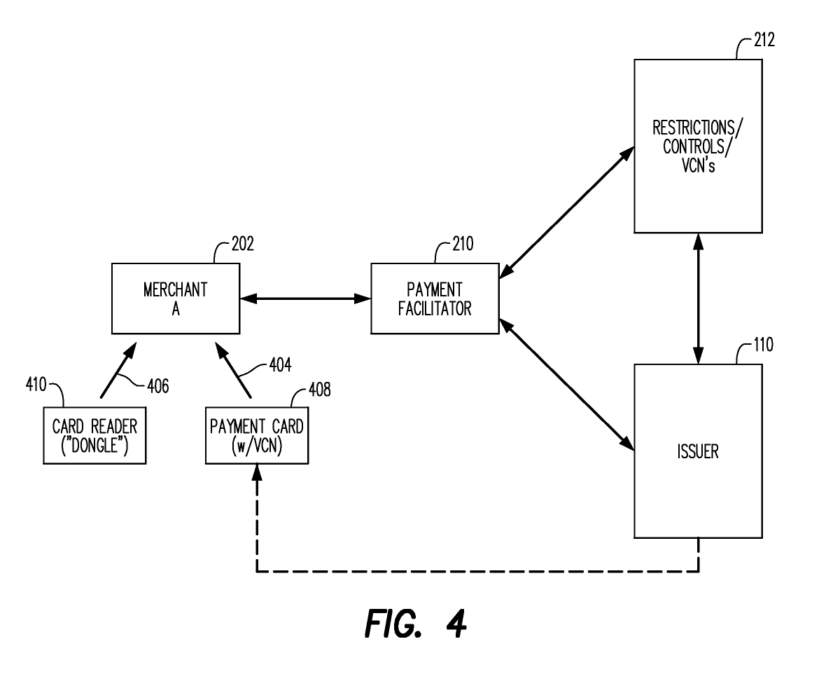

FIG. 4 is a diagram that illustrates aspects of the payment system 200 in relation to enrollment of SMEs/merchants. As noted above, the party that solicits the enrollment of the merchant (block 202 in FIG. 4 and in other drawings) may be the payment facilitator 210, to which the issuer 110 has extended a sizable credit line as discussed in connection with FIG. 3. Now the payment facilitator may extend a secured credit line/credit card account to the merchant 202, with the merchant's credit card account to be identified by a VCN generated in the account control facility 212 at the request of the payment facilitator 210; the VCN may be mapped to the credit account that was issued by the issuer 110 to the payment facilitator 210 and may be controlled in accordance with instructions provided from the payment facilitator 210 to the account control facility 212. The effect of the restrictions applied via the account control facility for the VCN in question may be that the merchant 202 is extended credit by the payment facilitator 210 on a secured/collateralized basis, with a variable credit limit, and with such risk mitigation requirements as the payment facilitator may establish in view of the creditworthiness and business position of the merchant 202.

Moreover, under the auspices of the payment facilitator 210, the merchant 202 may be enrolled as an acceptor of payment transactions. Both payment transactions accepted by the merchant 202 and charges to the credit card account of the merchant 202 may be cleared through the payment facilitator's account with the issuer 110. Furthermore, the issuer 110, in some embodiments, may be a source of business services/resources for the merchant 202, such as the services/resources described above in connection with block 214 (FIG. 2).

Continuing to refer to FIG. 4, through cooperation between the payment facilitator 210 and the account control facility 212, possibly via the issuer 110, the VCN for the merchant 202 may be associated with the credit account issued to the payment facilitator 210 by the issuer 110. The payment facilitator 210 may be empowered to establish controls at the account control facility 212 to be applied to the VCN for the merchant 202. As will be seen, the effect of such controls may be to increase the credit limit for the merchant's credit card account when transactions accepted by the merchant (qua merchant) are approved by the merchant's customer's account issuer and thereby become collateral held by the payment facilitator's account issuer 110. In some embodiments, the increase in the credit limit may match, dollar-for-dollar, the approved merchant-accepted transactions; in other embodiments or use-cases, and in order to reduce the payment facilitator's credit risk relative to the merchant, the payment facilitator may set controls at the account control facility 212 such that the credit limit is increased by a lower percentage than 100% of the amount of the merchant's accepted and approved transactions. In either case, it can be said that the increase in the credit limit corresponds to the amount of the payment account transaction accepted by the merchant 202.

Still further, the controls established at the account control facility 212 at the payment facilitator's behest may reduce the available credit for the merchant's credit card account when the merchant engages in purchase transactions (qua customer of another merchant) using the merchant's credit card account.

Arrows 404 and 406 in FIG. 4 respectively represent physical delivery to the merchant 202 of a payment card 408 and a card-reader/“dongle” device 410. This may occur in connection with the merchant's above-referenced enrollment as a credit card account holder and a payment account transaction acceptor. The payment card 408 may, for example, be embossed with or otherwise display the VCN that has been assigned to identify the merchant's credit card account via the payment facilitator 210 and the account control facility 212. Subject to the variable credit limit as described herein, the merchant 202 may use the payment card 408 for credit card purchases from other merchants.

The “dongle” is a known type of device, and may be connected to the merchant's smartphone (not separately shown) in a conventional manner to allow the smartphone to function as an “mPOS” device for accepting payment account transactions for purchases from the merchant 202. In a common embodiment, a dongle allows a swipe of a magnetic stripe card to be read by a smartphone. In some embodiments of the present disclosure, the dongle or other device and/or programming to be applied to the merchant's smartphone may in addition or alternatively modify the smartphone so that it is capable of reading contactless and/or contact integrated circuit payment cards.

In some embodiments, the dongle is in effect a payment card reader accessory for the merchant's mPOS device.

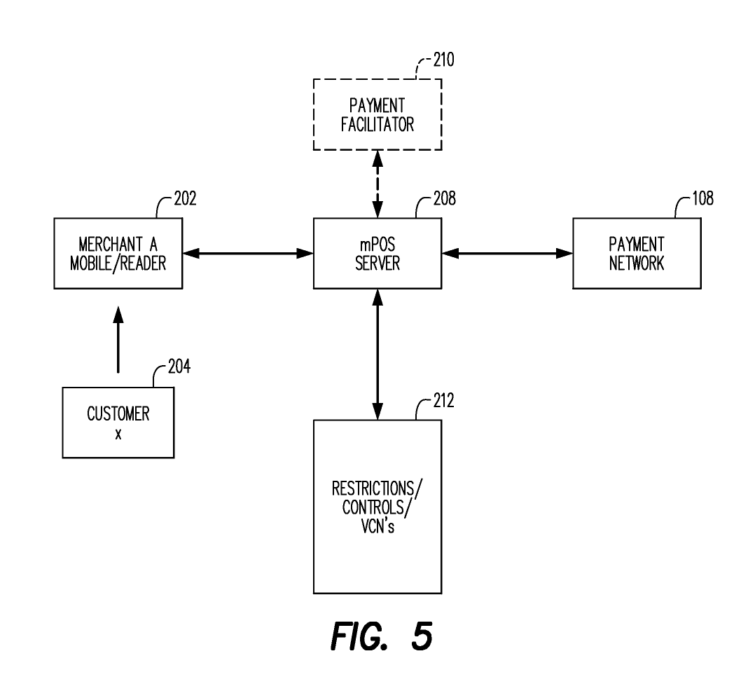

FIG. 5 is a diagram that illustrates aspects of the payment system 200 in relation to payment account transaction acceptance by the merchant 202. In FIG. 5, block 202 represents the merchant's mPOS device, as well as the merchant. The merchant's customer 204 presents the customer's payment card for reading by the merchant device 202 in connection with a purchase that the customer 204 is making from the merchant. Following in many respects the typical transaction described above in connection with FIG. 1, the merchant device 202 in FIG. 5 transmits a payment account transaction authorization request message to the mPOS server 208. (In some embodiments, the mPOS server may be operated by or on behalf of, and/or owned by, the payment facilitator 210, which is shown in phantom in FIG. 5.) The mPOS server 208 in turn routes the transaction authorization request message to the payment network 108. From the payment network 108, in accordance with conventional practices, the authorization request message is routed to the issuer (not shown in FIG. 5) of the payment account belonging to the customer 204. Also, in accordance with conventional practices, the issuer handles the authorization request message and transmits an authorization response message to the mPOS server 208 via the payment network 108. Assuming that all was in order with the payment account of the customer 204, the authorization response message may indicate that the requested transaction has been approved/authorized by the customer's account issuer. At this point, the mPOS server 208 may provide notice to the account control facility 212 of the transaction that has been accepted by the merchant 202 and approved by the merchant's customer's account issuer, such that the proceeds to come in connection with the transaction effectively have become collateral held by the issuer 110 (FIGS. 3 and 4) that issued the payment facilitator's credit account. With this security available to the payment facilitator relative to the merchant's obligations to the payment facilitator, the controls in effect at the account control facility 212 with respect to the merchant's credit card account (VCN-identified) may be established (in accordance with aspects of this disclosure) so as to instantaneously increase the credit limit for the merchant's credit card account. The amount of the increase in the credit limit may correspond to the amount of the approved transaction just accepted by the merchant 202. For example, the amount of the increase of the credit limit may be 100% of the amount of the accepted transaction or some lower percentage determined by the payment facilitator that issued the merchant's credit card account. With this immediate extension of credit to the merchant 202, the merchant effectively has immediate access to the funds taken in via the just-accepted payment account transaction. In practical terms, moreover, settlement of the accepted transaction may occur quite promptly, e.g., within one day, so that the merchant could possibly even withdraw the funds in cash from the merchant's account with the issuer 110 quite promptly after accepting the transaction. This may result in a significant improvement in the settlement time currently available to SME payment account acceptors.

It will be appreciated that the mPOS server 208 may also transmit the authorization response, or the outcome thereof, along to the merchant device 202.

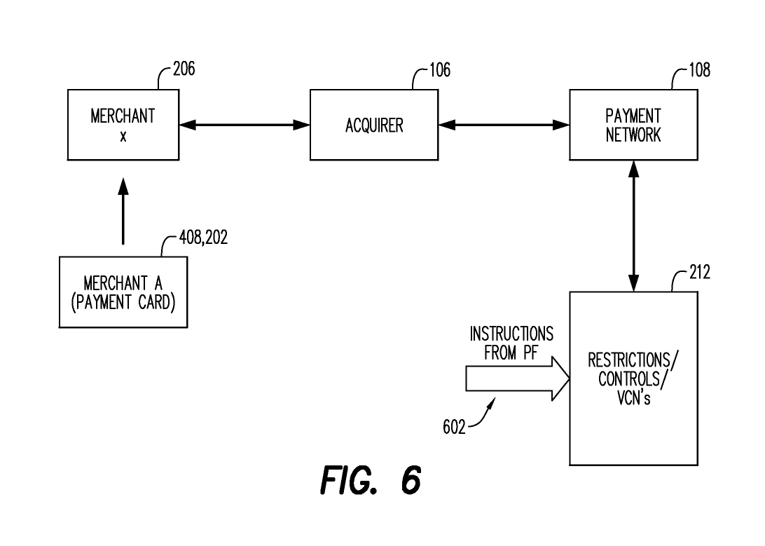

FIG. 6 is a diagram that illustrates aspects of the payment system 200 in relation to a payment account purchase transaction made by the merchant 202. The transaction illustrated in FIG. 6 shares similarities with the conventional transaction illustrated in FIG. 1, while also incorporating elements of the type of transaction processing employed in transactions subject to MasterCard's “In Control” service offering, as referred to above. As will be understood from discussion above, from the point of view of the account control facility 212 and the account issuer 110 (not shown in FIG. 6) the ultimate account holder exercising controls via the account control facility 212 is the payment facilitator 210 (not shown in FIG. 6), while the relevant VCN generated at the behest of the payment facilitator identifies the credit card account used by the merchant 202 to engage in the illustrated payment account purchase transaction.

More specifically, the merchant 202 (qua customer/credit card account holder) presents the merchant's payment card 408 to another merchant 206 for reading by the POS device (not separately shown) operated by or on behalf of the other merchant 206. The POS device operated by the merchant 206 reads the VCN assigned to the merchant 202's credit card account from the payment card 408. The other merchant 206 transmits a payment account transaction authorization request message to the other merchant's acquirer 106. It will be appreciated that the VCN is included as the payment account identifier in the authorization request message. The acquirer 106 routes the authorization request message to the payment network 108. Because the VCN is the account identifier, the transaction is routed to the account control facility 212. In a manner that may resemble in at least some respects the functionality of the above-mentioned “In Control” service offering, the account control facility applies the currently applicable credit limit/available credit amount for the merchant 202's credit card account to determine whether the transaction should be passed on to the payment facilitator's account issuer (not shown in FIG. 6) for approval of the transaction. If sufficient credit for the requested transaction is not available according to the controls in place on the merchant's credit card account, then the account control facility 212 may cause the requested transaction to be declined. Otherwise, the transaction is routed on to the payment facilitator's account issuer for what is highly likely to be approval (it is assumed that the payment facilitator has a high credit line, which is unlikely to be depleted). Assuming approval does take place, then the account control facility may reduce the available credit for the merchant 202's credit card account by the amount of the requested transaction. The outcome of decision-making by the account control facility/account issuer is routed back as an authorization response message to the other merchant 206 via the payment network 108 and the acquirer 106. Assuming approval, the purchase transaction by the merchant 202 is then consummated.

As indicated at 602 in FIG. 6, the rules/restrictions/controls applied by the account control facility 212 to the purchase transactions by the merchant 202 may be set in advance in accordance with instructions from the payment facilitator that enrolled the merchant 202 and issued the payment card 408.

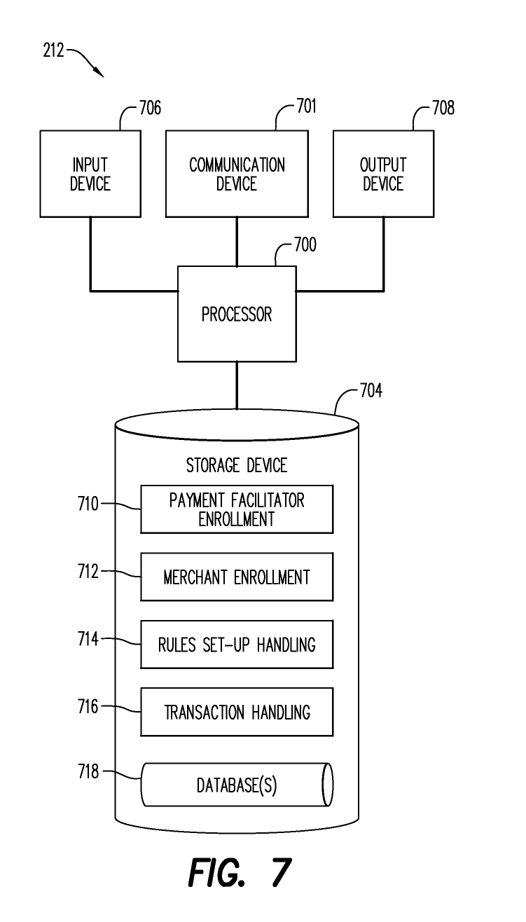

FIG. 7 is a block diagram representation of an example “account control facility,” and/or a “restrictions arbitration computer” 212 which may be operated as part of the system 200 shown in FIG. 2.

The restrictions arbitration computer 212 as illustrated in FIG. 7 may incorporate all of the functionality characteristic of computer resources that may be employed to provide a service offering like the above-mentioned MasterCard “In Control” service offering, which is known to those who are skilled in the art. According to aspects of the present disclosure, the functionality of the restrictions arbitration computer 212 may be leveraged to aid in the extension and management of credit services to SMEs, such as the merchant 202 referred to in the above discussion and in accordance with descriptions that accompanied the above-discussed FIGS. 3-6.

The restrictions arbitration computer 212 may be conventional in its hardware aspects but may be controlled by software to cause it to operate in accordance with aspects of the present disclosure. For example, the restrictions arbitration computer 212 may be constituted, at least in part, by conventional server computer hardware.

The restrictions arbitration computer 212 may include a computer processor 700 operatively coupled to a communication device 701, a storage device 704, an input device 706 and an output device 708. The storage device 704, the communication device 701, the input device 706 and the output device 708 may all be in communication with the processor 700.

The computer processor 700 may be constituted by one or more conventional processors. Processor 700 operates to execute processor-executable steps, contained in program instructions described below, so as to control the payments server 706 to provide desired functionality.

Communication device 701 may be used to facilitate communication with, for example, other devices (such as issuer computers, mPOS servers and computing facilities of one or more payment networks). Communication device 701 may include numerous communication ports (not separately shown) to accommodate numerous simultaneous transactions and other interactions, and may be capable of engaging in data communication over conventional computer-to-computer data networks.

Input device 706 may comprise one or more of any type of peripheral device typically used to input data into a computer. For example, the input device 706 may include a keyboard and a mouse. Output device 708 may comprise, for example, a display and/or a printer.

Storage device 704 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 704 stores one or more programs for controlling processor 700. The programs comprise program instructions that contain processor-executable process steps of restrictions arbitration computer 212, including, in some cases, process steps that constitute processes provided in accordance with principles of the present disclosure, as described herein.

The programs may include one or more conventional operating systems (not shown) that control the processor 700 so as to manage and coordinate activities and sharing of resources in the restrictions arbitration computer 212, and to serve as a host for application programs (described below) that run on the restrictions arbitration computer 212.

The programs stored in the storage device 704 may also include a payment facilitator enrollment application program 710. The payment facilitator enrollment application program 710 may control the processor 700 to enable the restrictions arbitration computer 212 to permit enrollment of payment facilitators 210 (FIG. 2). As will be understood from the above discussion of FIGS. 3-6, enrollment of a payment facilitator 210 with the restrictions arbitration computer 212 may enable issuance of VCNs against a “master” credit account issued by an account issuer 110 to the payment facilitator 210. As also noted above, the VCNs may identify credit card accounts issued to SMEs/merchants with variable credit limits. The credit limits may be managed and controlled through account control capabilities of the restrictions arbitration computer 212. The storage device 704 may also store a merchant (i.e., SME) enrollment application program 712 to control the processor 700 to enable the restrictions arbitration computer 212 to permit enrollment of the SMEs/merchants.

The storage device 704 may also store an application program 714 to enable payment facilitators to define, merchant-by-merchant, the nature of the rules that determine what form of variable credit limit and/or what parameters there will be for the credit limit for credit card accounts issued to the merchants.

Another application program that may be stored by the storage device 704 is for handling individual transactions and is indicated by reference numeral 716 in FIG. 7. For example, and as will be understood from previous discussion herein, merchant-accepted transactions, if approved, may be processed by the application program 716 to increase applicable credit limits, and proposed purchase transactions by merchants may be compared by the application program 716 to currently available credit resources in the applicable VCN-defined account, with potential provisional approval of the transaction subject to final approval by the payment facilitator's account issuer.

The storage device 704 may also store, and the restrictions arbitration computer 212 may also execute, other programs, which are not shown. For example, such programs may include a reporting application, which may respond to requests from system administrators for reports on the activities performed by the restrictions arbitration computer 212. The other programs may also include, e.g., one or more data communication programs, a database management program, website hosting software, device drivers, etc.

Reference numeral 718 in FIG. 7 indicates one or more databases that are maintained by the restrictions arbitration computer 212 on the storage device 704. Among these databases may be a payment facilitator database, a merchant database, a VCN database, a rules/controls database and a transaction database.

The application programs of the restrictions arbitration computer 212 as described above may be combined in some embodiments, as convenient, into one, two or more application programs.

Other components of the system 200 shown in FIG. 2 may exhibit the same hardware architecture and types of components as described above with respect to the restrictions arbitration computer 212. Such other components shown in FIG. 2 may include, for example, the mPOS server 208 and/or one or more servers operated on behalf of one or more of the account issuers/FIs referred to herein and/or one or more servers operated on behalf of one or more of the payment facilitators referred to herein.

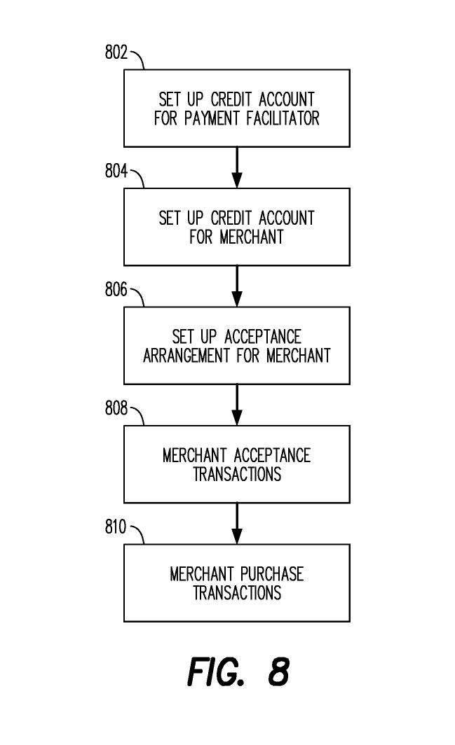

FIG. 8 is a high-level flow chart that illustrates a process that may be performed in the system 200 of FIG. 2. FIG. 8 may, at least in part, be considered an overview of the processes that were described above in connection with FIGS. 3-6, and the ensuing description of FIG. 8 should be read in conjunction with the descriptions of FIGS. 3-6.

At 802 in FIG. 8, a credit/credit card account may be issued by an account issuer 110 to a payment facilitator 210 and set up for control via the restrictions arbitration computer 212. The amount of credit available under the account issued to the payment facilitator may be ample, to permit the payment facilitator to engage in a business enterprise of extending credit to SMEs.

At 804 in FIG. 8, the payment facilitator 210 may arrange for issuance of a VCN at the restrictions arbitration computer 212, with the VCN to be assigned to identify a credit card account issued by the payment facilitator 210 to the merchant/SME 202. Thus step 804 may include setting up the above-described credit card account for the merchant 202. As noted above, a physical payment card 408 (FIG. 4) may be issued to the merchant 202 with the VCN stored and/or embossed/displayed on the card 408 as the account identifier for the credit card account issued to the merchant 202.

At 806 in FIG. 8, the payment facilitator 210 may set up necessary arrangements so that the merchant 202 is able to accept payment account transactions. This may include suitable recognition of the merchant 202 by the mPOS server 208 and the issuer 110 through which transactions accepted by the merchant 202 will be cleared. Thus, in effect, the issuer 110 in question (i.e., the issuer 110 shown in FIG. 4, and which issued the payment facilitator's credit card account) may also serve as an acquiring FI for the payment account transactions accepted by the merchant 202. Also, as noted above, this process step may include providing a dongle/card reader 410 (FIG. 4) to the merchant 202.

Block 808 in FIG. 8 represents payment account transactions accepted by the merchant 202 as described above in connection with FIG. 5.

Block 810 in FIG. 8 represents credit card account transactions engaged in by the merchant 202 in the role of a customer using the payment card 408 issued to the merchant 202 under the auspices of the payment facilitator 210. It will be understood that, in such transactions, the merchant 202 effectively accesses a credit card account identified by the VCN displayed on and/or stored in the payment card 408. It may also be the case that the merchant 202 may use the VCN for online purchases and/or other “card not present” payment account purchase transactions. It will be understood that at least some of the scenarios in which the merchant 202 charges transactions to the payment account identified by the VCN are described above in connection with FIG. 6.

To give one somewhat more concrete example of a use case in accordance with teachings of the present disclosure, the payment facilitator may enter into a business of issuing credit card accounts to taxi/limousine drivers, who also wish to accept payment account transactions in payment of the fares they charge to their customers. Thus a typical one of the drivers may fill the role of the merchant 202 as described hereinabove. The payment facilitator may do underwriting/due diligence to establish some assurance that the driver is creditworthy/trustworthy. Depending on the results of the underwriting process and/or the payment facilitator's appetite for risk, the payment facilitator may require an initial deposit of funds from the driver (e.g., to be held by the payment facilitator's account issuer 110 in an account issued to the driver) as initial security for the credit card account issued from the payment facilitator to the driver. The initial credit limit for the account may be equal to the amount of the initial deposit of funds made by the driver. In other instances, for example, the payment facilitator may extend a low initial credit limit to the driver without requiring an initial deposit (i.e., the driver's credit card account may only be partly secured). As in the scenario of FIG. 5, as the driver accepts payment account transactions in payment of fares, and those transactions are approved by the driver's customer's account issuer, all or a fixed percentage (e.g., 80%) of the accepted and approved transaction amounts may be applied to increase the effective credit limit for the driver's credit card account. To the extent that credit is available under that account, the driver may charge expenses (e.g., purchases of gasoline) to the account. There may be effectively immediate access by the driver to (at least some of) the proceeds of the fares via the credit card account issued to the driver from the payment facilitator. In some embodiments, the driver may use the VCN for his/her credit card account for other expenses, such as filling a toll-payment account (e.g., an EZPass® account), or for other card-not-present transactions. In some embodiments, the driver may charge personal expenses as well to his/her credit card account. In some embodiments, the payment facilitator may set up restrictions on the driver's credit card account such that charges to the account may only be made for certain categories of purchases required for business purposes by the driver. In some embodiments, the driver may, in effect, pay himself/herself a salary by making withdrawals/transfers from the account into which the fare transactions are settled.

It will be appreciated that the above-described use case may be implemented in the context of a developed country. With perhaps some minor modifications, it could also be adapted to the context of a developing country, and may give banking access (via the payment facilitator) for a merchant who may otherwise be “unbanked.” Benefits of this sort of arrangement, at least in the developed-country context, may include better underwriting (the payment facilitator may have industry-specific knowledge or otherwise be better “tuned in” to SMEs or certain categories thereof than the typical FI), faster onboarding for new payment account transaction acceptors, and faster settlement (e.g., one or two days, versus perhaps a week under conventional arrangements). One additional advantage of the arrangements as described herein is that it may be feasible for a payment facilitator to extend credit virtually instantaneously to an unknown party (the latter being in the role of the merchant 202 as referred to above). In some embodiments, for example, entities such as social networks (e.g., Facebook® or Twitter®) and or other entities such as Google®, eBay®, or Instagram® may find it advantageous to take on the role of payment facilitator as described herein.

To give just one further developing-country type of use case, the teachings of this disclosure may be implemented to support a payment facilitator that wishes to operate as a microlender.

While a taxi/limousine driver has been given as an example SME in some use-cases mentioned above, it should be understood that many other types of SMEs, in developed- or developing-country contexts, could also be in the role of the merchant 202 as described herein.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
establishing a credit account for a merchant;
setting a variable credit limit for the credit account;
receiving an indication that (i) the merchant has accepted a payment account transaction to be charged to a customer's payment account, with a transaction amount associated with the payment account transaction; and (ii) the payment account transaction has been authorized by an issuer of the customer's payment account; and
responding in real time to the indication by instantaneously increasing the variable credit limit for the credit account by an amount that corresponds to the transaction amount.

2. The method of claim 1, wherein the credit account is a credit card account.

3. The method of claim 2, wherein the credit card account is identified by a virtual card number (VCN).

4. The method of claim 3, wherein the payment account transaction is a first payment account transaction, the method further comprising:
receiving a request to charge a second payment account transaction to the credit card account;
authorizing the second payment account transaction; and
decreasing an amount of available credit for the credit card account by an amount that corresponds to the second payment account transaction.

5. The method of claim 4, wherein the second payment account transaction was initiated by the merchant using a physical payment card that displays the VCN.

6. The method of claim 4, wherein the step of authorizing the second payment account transaction includes confirming that the amount that corresponds to the second payment account transaction does not exceed a currently available amount of credit for the credit card account as in effect prior to said decreasing step.

7. The method of claim 4, wherein the credit account is a first credit account;
the method further comprising:
charging the second payment account transaction to a second credit account that was issued to an entity that generated the VCN.

8. The method of claim 7, wherein the entity that generated the VCN is a payment facilitator.

9. A method comprising:
receiving, by a payment facilitator, issuance of a first credit account from an issuer, the credit account identified by a first account identification number;
generating, by the payment facilitator, a virtual card number (VCN); and
issuing, by the payment facilitator, a second credit account to a merchant, said second credit account identified by said generated VCN;
said second credit account arranged to allow initiation of purchase transactions using the generated VCN, said purchase transactions submitted for approval by the issuer against the first credit account.

10. The method of claim 9, wherein the payment facilitator sets a variable credit limit for the second credit account, said variable credit limit being decreased from time to time to reflect purchase transactions made by the merchant using the generated VCN, said variable credit limit being increased from time to time to reflect payment account transactions accepted by the merchant and held as collateral for the merchant's obligations to the payment facilitator.

11. The method of claim 10, wherein the first credit account is a credit card account identified by the generated VCN.

12. The method of claim 10, wherein the variable credit limit is increased in response to approvals of said payment account transactions accepted by the merchant.

13. The method of claim 12, wherein said approvals are issued by issuers of payment accounts belonging to customers of the merchant who engaged in said payment account transactions accepted by the merchant.

14. The method of claim 9, wherein the merchant initiates at least some of the purchase transactions using a physical credit card that displays the generated VCN.

15. The method of claim 9, wherein:
at least some of said purchase transactions are first routed to a restrictions arbitration computer, and then second routed from the restrictions arbitration computer to a server computer operated by the issuer.

16. A method comprising:
receiving a transaction authorization request message from a mobile device, the message for requesting a payment account transaction;
routing the transaction authorization request message to an account issuer via a payment network;
receiving a transaction authorization response message from the account issuer via the payment network, the transaction authorization response message indicating approval of the requested payment account transaction; and
responding to the transaction response message by reporting the approved purchase transaction to a restrictions arbitration computer.

17. The method of claim 16, further comprising:
further responding to the transaction authorization message by notifying the mobile device that the requested transaction has been approved.

18. The method of claim 17, wherein all of said steps are performed by an mPOS (mobile point of sale) server computer.

19. The method of claim 16, wherein the account issuer issued a payment account to a customer, the customer engaged in a transaction with a merchant that is operating the mobile device.

20. The method of claim 16, wherein the mobile device includes a payment card reader accessory.
